(19) United States
(12) Patent Application Publication
(10) Pub. No.: US 2004/0173224 A1
(43) Pub. Date: Sep. 9, 2004

(54) Nicotine salts having improved taste, process for their preparation and their use

(76) Inventors: Andreas Burgard, Frankfurt am Main (DE); Margit Dorr, Hohen-Suelzen (DE)

Correspondence Address: ProPat, L.L.C., 425-C South Sharon Amity Road, Charlotte, NC, 28211, US

(21) Appl. No.: 10/800,364

(22) Filed: Mar. 12, 2004

Related U.S. Application Data
(63) Continuation of application No. 09/810,815, filed on Mar. 16, 2001, now abandoned.

(30) Foreign Application Priority Data
Mar. 20, 2000 (DE) 100 13 712.1

(51) Int. Cl. A23G 3/30

(52) U.S. Cl. 131/270; 131/271

(57) ABSTRACT

Salts formed from nicotine and anion-forming sweeteners, for example acesulfame or acesulfame-K, in a molar ratio of 1:1 or 1:2, in which case the sweetener molecules can be identical or different, are distinguished by a pleasant sweet taste which masks the nicotine taste even after a long residence time in the mouth, and are therefore suitable for producing preparations, in particular chewing gum, chewing tablets or compressed compositions, which can be used for oral administration of nicotine, for example in withdrawal from smoking.

This application is a continuation of U.S. application Ser. No. 09/810,815 filed Mar. 16, 2001, which is hereby incorporated by reference herein in its entirety.

### BACKGROUND OF THE INVENTION

Owing to continuous consumption of cigarettes, smokers are habituated to regularly taking nicotine. Because of the disadvantageous effects of smoking on health, many smokers are interested in giving up smoking.

This intention however fails in many cases owing to the fact that the regular consumption of nicotine has already led to a physical dependency. For slow withdrawal, various routes have been proposed, for example applying nicotine to the skin in the form of impregnated plasters or supplying it orally, for example via a chewing gum (U.S. Pat. No. 5,488,962). Supply via chewing gum additionally has the advantage that the oral intake compensates for the need for sucking cigarettes.

However, nicotine has a taste which, when consumed alone, is perceived as unpleasant. It is generally described as sharp to pepper-like and bitter. This unpleasant taste hinders the acceptance of chewing gum with added nicotine which should be chewed regularly for withdrawal from smoking, particularly in the initial phase. In order to improve the acceptance of nicotine-containing chewing gums or other preparations which can be consumed orally, there is therefore the requirement for improving or masking the unpleasant taste of nicotine.

There have been a whole series of attempts to mask the unpleasant taste of nicotine. The use of flavoring substances and taste substances such as peppermint or strawberry flavorings has not previously led to satisfactory masking of the nicotine taste. Only the use of the inclusion compounds, for example with cyclodextrins (WO 97/41843) is suitable to date for inducing an improvement in taste. However, such inclusion compounds alone do not lead to sufficient taste acceptance, rather additional taste substances must be used, for example in chewing gum.

Therefore, the manufacturers of nicotine chewing gums have already attempted to mask the unpleasant taste of nicotine by combination with sweeteners, generally saccharin and/or acesulfame-K, which are incorporated into the chewing gum base mass. The sweeteners as such, however, cannot mask the nicotine taste, so that the nicotine taste during the chewing taste becomes increasingly more clearly perceptible and becomes more clearly pronounced with the chewing process.

This taste impression of the abovementioned mixtures can be reproduced by simple sensory experiments with aqueous solutions, since both nicotine and the sweeteners are water soluble. For this purpose, solutions of nicotine containing various sweeteners such as acesulfame-K, saccharin sodium or aspartame are prepared in water and a taste sample is compared with a nicotine-containing aqueous solution (10 mg of nicotine in 100 ml of water). The various combinations of nicotine with each of the sweeteners and the corresponding taste impressions are shown in table 1.

TABLE 1
Taste testing of the combination of nicotine with
sweeteners

| Substances | mg of dissolved substance in 100 ml of water | | | | |
|---|---|---|---|---|---|
| Nicotine | 10 | 10 | 10 | 10 | 10 |
| Acesulfame-K | — | 12 | 24 | 12 | 12 |
| Saccharin Na | — | — | — | 15 | — |
| Aspartame | — | — | — | — | 15 |
| Taste | Immediately | Immediately | Immediately | Immediately | Immediately |
| | pepper- | pepper- | pepper- | pepper- | pepper- |
| | like, | like, | like, | like, | like, |
| | rough, | rough, | rough, | rough, | rough, |
| | persistent | persistent | persistent | persistent | persistent |
| | unpleasantly | unpleasantly | unpleasantly | unpleasantly | unpleasantly |
| | bitter | bitter | bitter | bitter | bitter |
| | taste | taste | taste | taste | taste |
| | | with | with | with | with |
| | | accompanying | accompanying | bitter | accompanying |
| | | slight | stronger | and | slight |
| | | sweet | sweet | sweet | sweet |
| | | taste | taste | after- | taste |
| | | | | taste | |

The results verify that the unpleasant taste of nicotine is not substantially modified by simple addition of the abovementioned sweeteners. Therefore, there is still the requirement for masking the unpleasant taste of nicotine in preparations which are taken orally, in particular in chewing gum, during the chewing process.

WO 99/04822 describes 1:1 salts of a sweetener and an unpleasantly tasting pharmaceutical. Salts of an anionic sweetener and nicotine are not described.

WO 00/12067 describes 1:1 salts of saccharin with synthetic non-alkaloidal medicinal organic bases. Salts of an anionic sweetener and nicotine are not described.

EP-B 0 046 506 describes Vincamine saccharinate and medicaments containing this. Salts of an anionic sweetener and nicotine are not described.

It has now been found that nicotine, owing to its basic character, can react with anion-forming substances, which are present in the form of their corresponding acid, to give salt-like compounds.

Not only are salts prepared here from one molecule of nicotine and one molecule of sweetener, but also defined compounds of one molecule of nicotine and two molecules of sweetener may be prepared, in which even two different sweeteners can be used. Surprisingly, all of these compounds are distinguished by a pleasant sweet taste, from which the unpleasant components of nicotine are substantially absent. They consist only of components which are used in any case, for example in nicotine-containing chewing gums, and make further working steps, such as the preparation of inclusion compounds mentioned in WO 97/41843, superfluous. Thus this invention is an important advance in the production, composition and use of nicotine-containing preparations for withdrawal from smoking.

### BRIEF DESCRIPTIONS OF THE INVENTION

The present invention thus relates to compounds or salts of nicotine and anion-forming sweeteners or their physiologically acceptable salts or sweeteners which have acid character in free form, or their physiologically acceptable salts. These compounds can also be present as what are termed acid-addition salts, preferably with HCl, or other physiologically acceptable acids, for example acetic acid or sulfuric acid.

### DETAILED DESCRIPTION OF THE INVENTION

Suitable compounds for the preparation of these compounds are in principle all sweeteners or their physiologically acceptable salts, such as in particular the potassium salt of acesulfame (acesulfame-K), which are able to form anions, including in particular

acesulfame and other oxathiazinone sweeteners

alitame

aspartame and aspartame-like di- and tripeptides

cyclamate and other sulfamate sweeteners

glycyrrhizin

neotame

saccharin

gluconic acid

Acesulfame (acesulfame-H) and acesulfame-K are particularly preferred.

A multiplicity of combinations are possible here, in particular in the case of the compounds of one molecule of nicotine and two sweetener molecules. By suitable choice of the sweeteners, in particular in compounds having two different sweeteners, surprisingly the sweet taste may be modified, in particular the perception of sweetness with time, firstly with respect to masking the nicotine taste, secondly for setting an optimum overall taste impression. This is a critical advantage compared with the 1:1 compounds of 1 mol of sweetener and 1 mol of nicotine.

The present invention thus also relates to a process for preparing the inventive nicotine-sweetener compounds by reacting nicotine with sweeteners in the form of their free acids (for example acesulfame-H) in a suitable solvent. Suitable solvents are preferably water and/or water-miscible solvents, for example alcohols. Sweeteners suitable for this direct reaction are preferably acesulfame, cyclamate, glycyrrhizin, gluconic acid and/or saccharin. A process variant is that the sweeteners or their salts (for example acesulfame-K) are reacted with nicotine in a solvent as described above in the presence of a physiologically harmless acid, preferably hydrochloric acid, or other suitable inorganic or organic acids, for example acetic acid or sulfuric acid, and the resultant acid addition salts (cf., for example, diagram 1) of the nicotine-sweetener compounds are isolated.

The starting materials for the preparation of the inventive compounds are commercially available or can be prepared according to methods known from the literature; for example acesulfame/acesulfame-K cf. EP-A 0 155 643.

The nicotine-sweetener compounds, salts or adducts are obtained very simply from solutions, preferably from aqueous solutions, of nicotine and the corresponding acid of the respective sweetener or, for example in a hydrochloric acid solution of the respective sweetener, as shown in the examples below, in particular for acesulfame-H. The resulting reaction solutions are freed from the solvent in a suitable manner, for example under reduced pressure. The nicotine-sweetener compounds, according to ¹H-NMR are present as 1:1, preferably as 1:2 or 1:1:1 adducts. To prepare compounds without additional salt content (no acid addition salts), preferably those sweeteners are used which are acids in the free form.

The invention further relates to the use of said compounds for preparing solid or liquid preparations which are suitable for oral supply of nicotine, preferably in the form of chewing gum, chewing tablets, compressed compositions or similar preparations. In addition, general preparations which comprise the inventive compounds are included by the invention.

The examples below are intended to describe the invention in more detail without restricting its scope.

### EXAMPLE 1

Preparation of a 1:1 Salt of Nicotine and Acesulfame-H (cf. Diagram 1).

20 mmol (3.244 g) of nicotine are dissolved in 20 ml of water and 20 mmol (3.263 g) of acesulfame-H are added. The reaction mixture is then concentrated under reduced pressure. A yellow-brown oil results with 100% yield, which according to ¹H-NMR is present as 1:1 adduct.

### EXAMPLE 2

Preparation of a 1:1:1 Salt of Nicotine, Acesulfame-H and Saccharin-H (cf. Diagram 2)

20 mmol (3.244 g) of nicotine are dissolved in 20 ml of water and 20 mmol (3.263 g) of acesulfame-H are added. Then a further 20 mmol (3.664 g) of saccharin-H are added. The reaction mixture is then concentrated under reduced pressure. A yellow-brown oil results with 100% yield which according to ¹H-NMR is present as 1:1:1 adduct.

### EXAMPLE 3

Preparation of a 1:2 Salt of Nicotine and Acesulfame-H (cf. Diagram 2)

20 mmol (3.244 g) of nicotine are dissolved in 20 ml of water and 40 mmol (6.526 g) of acesulfame-H are added. The reaction mixture is then concentrated under reduced pressure. A yellow amorphous solid results with 100% yield which according to ¹H-NMR is present as 1:2 adduct.

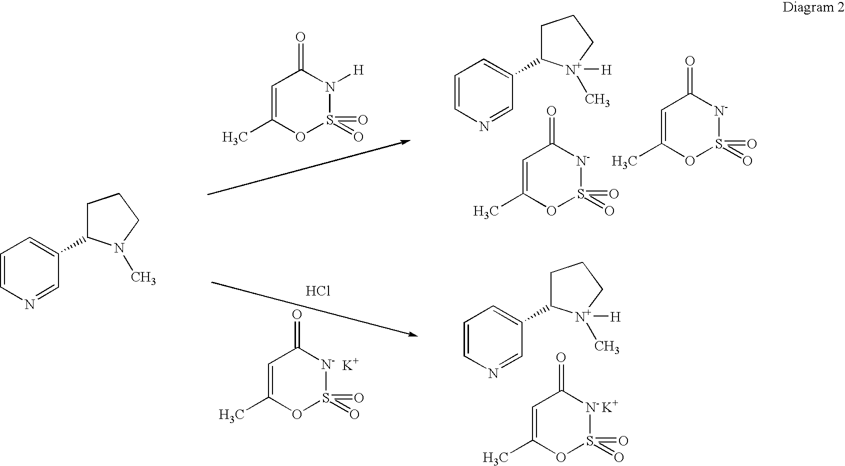

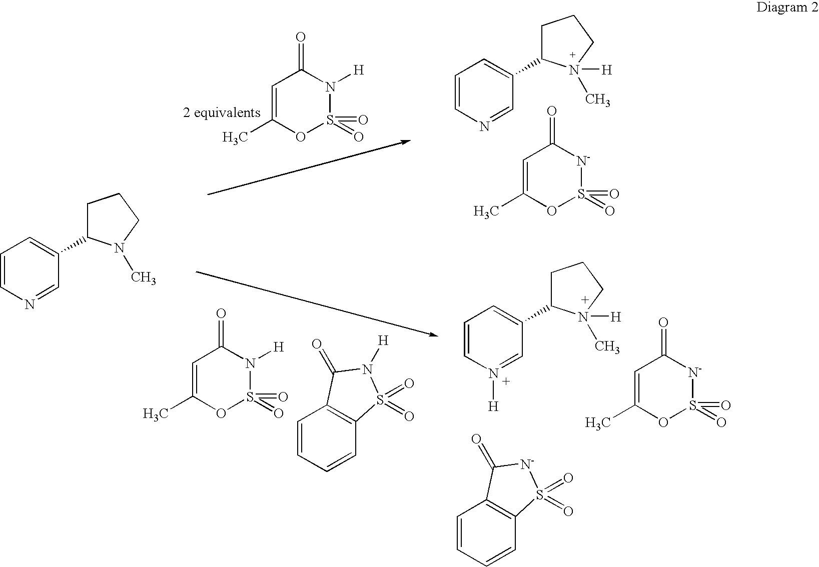

The various nicotine-sweetener compounds in a molar ratio of 1:1 and 1:2 or 1:1:1 were subjected to sensory testing in a taste test in comparison with an aqueous nicotine solution (10 mg of nicotine in 100 ml of water). Example 4 shows the results of such testing.

### EXAMPLE 4

Nicotine-Sweetener Compounds in a Ratio of 1:1 and 1:2 or 1:1:1

| | Compound | | | |
|---|---|---|---|---|
| | | | 1:1:1 | 1:1:1 |
| | 1:1 | 1:2 | nicotine- | nicotine- |
| | nicotine- | nicotine- | acesulfame- | acesulfame- |
| | acesulfame | acesulfame | saccharin | aspartame |
| | salt | salt | salt | salt |
| mg of | 20 | 31 | 35 | 66 |
| dissolved | | | | |
| adduct in | | | | |
| 100 ml | | | | |
| of | | | | |
| water | | | | |
| Taste | Immediately | Immediately | Immediately | Immediately |
| | sweet, | initiating | initiating | initiating |
| | after | marked | weak | strong |
| | about 10 | sweetness, | sweetness, | sweetness, |
| | seconds, | persistent, | metallic, | persistent, |
| | paprika- | initially | somewhat | after 5 |
| | like | sour, no | bitter off | minutes: |
| | taste, | nicotine | taste and | no |
| | then | taste, | aftertaste, | nicotine |
| | pepper- | after 5 | after 5 | taste |
| | like mild | minutes: | minutes: no | |
| | | no | nicotine | |
| | | nicotine | taste | |
| | | taste | | |

The results verify that, in contrast to the simple mixture of free nicotine with sweeteners, the unpleasant nicotine taste can be masked by salt formation or adduct formation of nicotine with sweeteners.

Whereas in the case of the 1:1 adducts the nicotine taste can be recognized again after a relatively long residence time in the mouth, the nicotine taste in the case of 1:2 or 1:1:1 adducts of nicotine with the respective anions of the sweeteners can surprisingly even be completely eliminated, so that even after some minutes of residence time in the mouth no nicotine taste can be detected.

The inventive compounds are stable and do not decompose even during incorporation into chewing gum or other preparations suitable for withdrawal from smoking. In particular, they can be used in intermediate products or precursor products without nicotine and sweeteners separating. Therefore, they may be incorporated without problem into the preparations with which they are to be consumed, for example chewing gum, chewing tablets, compressed compositions or other preparations for oral use.

The use is described by the following examples.

### EXAMPLE 5

Incorporation into Chewing Gum

For incorporation of the inventive compounds into chewing gum, sugar-free chewing gum strips are produced from the generally known ingredients chewing gum base, sugar-free sweeteners, such as sugar alcohols and synthetic sweeteners, glycerol and flavoring substances and the inventive compounds according to generally known technology, that is to say the ingredients are charged one after the other into the warmed chewing gum base and are incorporated uniformly. Shaping and portioning are then carried out as usual. The ingredients correspond to those customarily used, that is to say in the case of sugar alcohols, for example, sorbitol, xylitol, mannitol, maltitol, isomalt, lactitol, erythritol, mixtures of sugar alcohols and sugar alcohols in syrup form, for example sorbitol syrup and maltitol syrup. If wanted, for additional sweetening of the chewing gums, all known sweeteners can be used, for example acesulfame-K, aspartame, cyclamate, saccharin, thaumatin neohesperidins DC, sucralose, brazzein, neotame.

The dosage of the nicotine salts is dependent on the amount of nicotine which is to be present in a strip of chewing gum. In order that, for example, 2 mg of nicotine is present in a chewing strip 3 g in mass, 6 mg of the described 1:2 salt of nicotine and acesulfamic acid must be used or else 7.61 mg of the described nicotine-acesulfamic acid-aspartame salt. Similarly, the dosage of nicotine can be increased by increasing the dosage of the nicotine salts.

The nicotine salts can also be incorporated into sugar-containing chewing gum formulas. For this, instead of, or together with, the sugar substitutes, the sugars customarily used, for example sucrose and glucose syrup are used. The resulting chewing gums have a pleasant sweet taste which, even in the case of relatively long chewing, is not replaced by bitter taste components.

### EXAMPLE 6

Incorporation into Compressed Compositions, Tablets or Chewing Tablets

For incorporation of the inventive compounds into compressed compositions, sugar-free or sugar-containing compressed compositions, tablets or chewing tablets are produced with the use of sugar-free sweeteners such as sugar alcohols and synthetic sweeteners, aids, binders and flavoring substances and the inventive compounds according to generally known technology, that is to say the ingredients are homogeneously mixed one after the other and pressed to form compressed compositions or shaped to form tablets. The ingredients correspond to those customarily used, that is to say in the case of sugar alcohols, for example, sorbitol, xylitol, mannitol, maltitol, isomalt, lactitol and erythritol and mixtures of sugar alcohols. In the case of sugar-containing compressed compositions and tablets, sugars, for example sucrose, are used either exclusively or in combination with sugar alcohols. For additional sweetening of the compressed compositions and tablets, all known intensive sweeteners can be used, for example acesulfame-K, aspartame, cyclamate, saccharin, thaumatin, neohesperidins DC, sucralose, brazzein, neotame. The dosage of the nicotine salts is dependent on the amount of nicotine which is to be present in a compressed composition or a tablet. For a dose of 2 mg of nicotine in a compressed composition or a tablet, 6 mg of the described 1:2 salt of nicotine and acesulfamic acid must be used or else 7.61 mg of the described nicotine-acesulfamic acid-aspartame salt. Similarly, the dosage of nicotine can be increased by increasing the dosage of nicotine salts.

The resulting compressed composition or tablet has a pleasant sweet taste which is not replaced by bitter taste components even in the event of relatively long sucking or chewing.

What we claim is:

1. A compound of nicotine and a sweetener or of nicotine and sweeteners as well as acid-addition salt with their physiologically acceptable salts a physiologically acceptable acid.

2. A compound as claimed in claim 1, wherein nicotine and sweetener are present in a molar ratio of 1:1 or 1:2, in which latter case the sweetener molecules are identical or different.

3. A compound as claimed in claim 1 or 2, wherein the sweetener used is acesulfame or an other oxathiazinone sweetener, alitame, aspartame or an aspartame-like dipeptid and tripeptid, cyclamate or an other sulfamate sweetener, glycyrrhizin, neotame, saccharin or gluconic acid or their physiologically acceptable salts.

4. A compound as claimed in claim 1, wherein the sweetener used is acesulfame or acesulfame-K alone or in combination with a further sweetener or with its physiologically acceptable salt.

5. A process for producing a compound as claimed in claim 1, by
a) reacting, in a suitable solvent, nicotine with one or 2 sweeteners, which are identical or different, in the form of their free acid and then isolating the reaction product formed, or
b) reacting, in a suitable solvent, nicotine with one or 2 sweeteners, which are identical or different, or with their physiologically acceptable salts in the presence of a physiologically acceptable acid, and then isolating the reaction product formed.

6. The process as claimed in claim 5, wherein water or water-miscible solvents or water and water-miscible solvents are used as solvent.

7. The process as claimed in claim 5, wherein the physiologically acceptable acid used is hydrochloric acid.

8. Method of manufacturing a chewing gum by incorporating a compound according to claim 1 into a chewing gum raw material.

9. Method of manufacturing a chewing tablet by incorporating a compound according to claim 1 into a chewing tablet raw material

10. A solid or liquid preparation, in the form of a chewing gum, a chewing tablet or a compressed composition, for the oral administration of nicotine, comprising a compound as claimed in claim 1.
